(19) United States
(12) Patent Application Publication
(10) Pub. No.: US 2008/0243040 A1
(43) Pub. Date: Oct. 2, 2008

(54) CHAIR-TYPE MASSAGE MACHINE

(76) Inventors: Shogo Kuwabara, Konan-shi (JP); Yoshitoshi Morita, Nishiwaki-shi (JP)

Correspondence Address: ECKERT SEAMANS CHERIN & MELLOTT, 600 GRANT STREET, 44TH FLOOR, PITTSBURGH, PA, 15219, US

(21) Appl. No.: 12/056,441

(22) Filed: Mar. 27, 2008

(30) Foreign Application Priority Data
Mar. 29, 2007 (JP) 2007-086513

(51) Int. Cl. A61H 7/00

(52) U.S. Cl. 601/149; 601/148; 601/84

(57) ABSTRACT

A chair-type massage machine is provided which is adapted to give a twisting massage to the upper half of the body of the user. The massage machine comprises a seat 12 for the user to sit in, and a backrest 20 disposed at a rear end of the seat, the backrest being provided with a pair of opposite therapeutic air bags 30, 32 for massaging the back of the user. The pair of opposite therapeutic air bags 30 32 are arranged in a V shape and spaced apart by a large distance at an upper side of the backrest 20, the distance decreasing from portion to portion downward.

### FIELD OF THE INVENTION

The present invention relates to massage machines of the chair type comprising air bags for massaging the upper half of the body of the person to be treated, and more particularly to a chair-type massage machine adapted to give a twisting massage to the upper half of the body.

### BACKGROUND ART

Chair-type massage machines are known which comprise a seat for the user to sit in, a backrest pivotally movably supported by the seat and a pair of air bags arranged respectively at opposite sides of the backrest for massaging the back of the user [see, for example, Patent Literature 1 (JP1998-272165A)].

With the massage machine of Patent Literature 1, the air bags in the backrest are arranged as spaced apart by a distance gradually increasing from portion to portion downward so as to be positioned along the ribs. The air bags inflate along the ribs of the user, whereby the back of the user is massaged as by being pushed forward in its entirety.

When to be massaged, the upper half of the body of the user is given a twisting massage to correct the distortion of the spine and relax the muscles of the back, thereby giving a massage effect to the greatest possible extent.

However, the chair-type massage machine described above is unable to twist the upper half of the user.

### SUMMARY OF THE INVENTION

An object of the present invention is to provide a chair-type massage machine which is adapted to twist the upper half of the body of the user.

To fulfill the above object, the present invention provides a chair-type massage machine comprising a seat for the user to sit in, and a backrest disposed at a rear end of the seat, the backrest being provided with a pair of opposite therapeutic air bags for massaging the back of the user,

the pair of opposite therapeutic air bags being arranged in a V shape and spaced apart by a large distance at an upper side of the backrest, the distance decreasing from portion to portion downward.

The right upper half body and the left upper half body of the user are pushed forward alternately by alternately inflating the therapeutic air bags which are spaced apart by a large distance at the shoulder side of the user, whereby a twisting massage can be given to the back effectively with the spine positioned at the center. This makes it possible to correct the spine, soften or relax the muscles in the back and stretch these muscles, relieving the upper half body of stiffness very effectively.

### BRIEF DESCRIPTION OF THE DRAWINGS

FIG. 1 is perspective view of a chair-type massage machine of the invention;

FIG. 2 is a front view of the massage machine;

FIG. 3 is a diagram showing the arrangement of therapeutic air bags and head holding air bags relative to the user;

FIG. 4 is a diagram showing opposite therapeutic air bags as inflated alternately with the head holding air bags inflated;

FIG. 5 is a perspective view showing a chair-type massage machine having a separable backrest;

FIG. 6 includes sectional views showing pipes and hoses for connecting a head segment of the backrest to a back segment thereof;

FIG. 7 is a perspective view of a chair-type massage machine wherein central air bags are disposed between the therapeutic air bags;

FIG. 8 is a diagram showing opposite therapeutic air bags as inflated alternately with the central air bags inflated; and

FIG. 9 is a perspective view of a chair-type massage machine wherein central air bags are disposed between the therapeutic air bags in a V-shaped arrangement.

### DESCRIPTION OF THE PREFERRED EMBODIMENTS

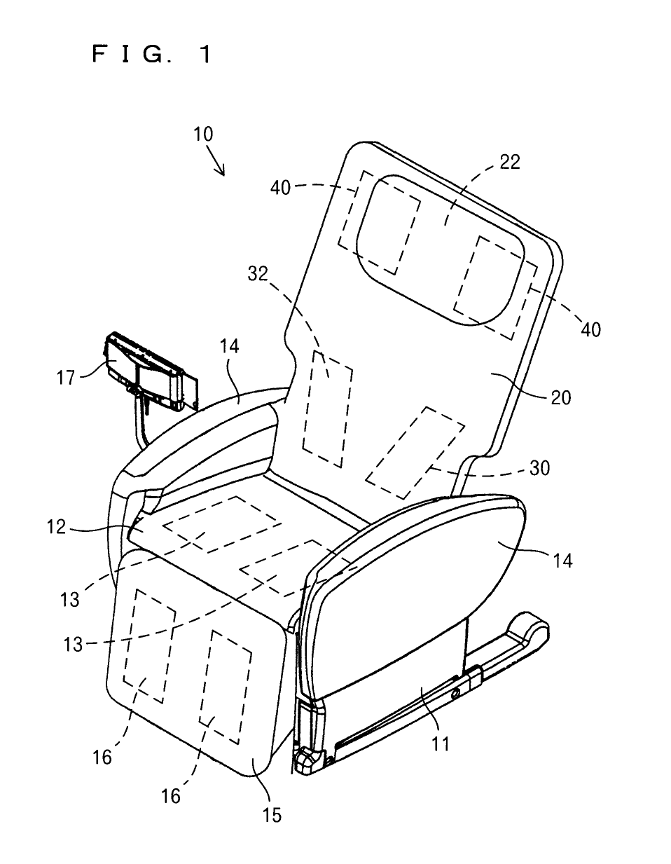

FIG. 1 shows an example of chair-type massage machine 10 of the invention.

The chair-type massage machine 10 comprises a seat 12 provided on a seat frame 11 for the user to sit in, a backrest 20 pivotably supported by the rear end of the seat 12, armrests 14, 14 provided at opposite sides of the seat 12, and leg massage means 15 for massaging the calves of the user. One of the armrests 14 is provided with a control unit 17 for operating the massage machine 10 and displaying various items of information about the machine 10.

The backrest 20, seat 12 and leg massage means 15 are provided with air bags 30, 32, 40, 13, 16 which are inflated or contracted by supplying or discharging compressed air.

Incidentally, known massage means are usable for the seat 12 and leg massage means 15, and the means used in the present embodiment are not limitative. Furthermore, such massage means can be dispensed with.

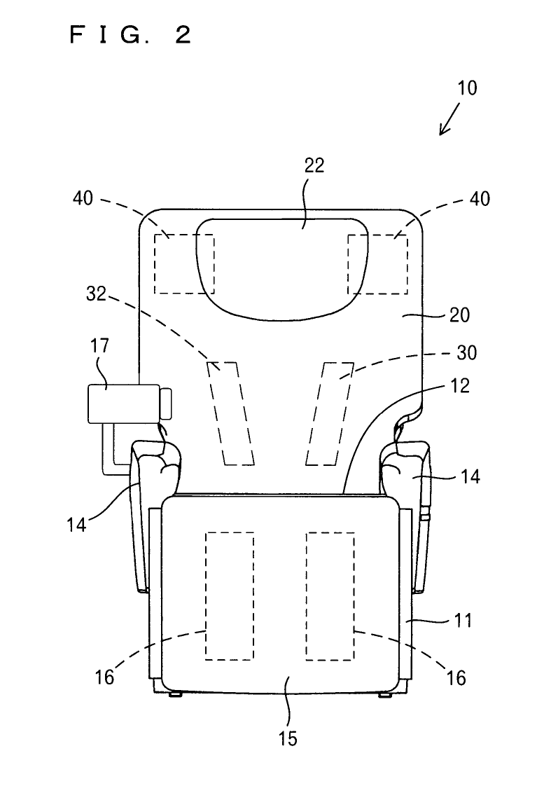

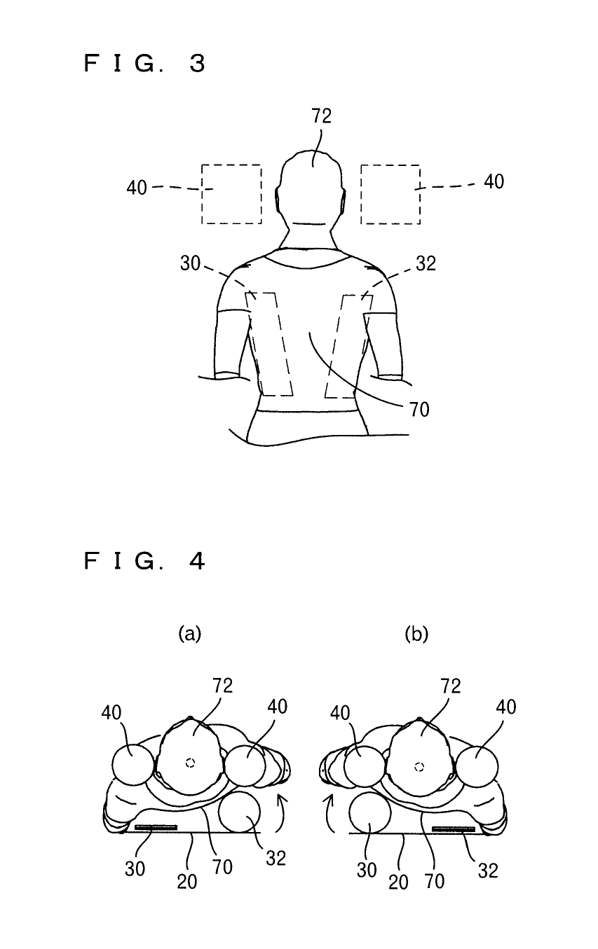

With reference to FIGS. 1 and 2, a pair of opposite therapeutic air bags 30, 32 are arranged in the backrest 20 at the portion thereof (see FIG. 3) for the back 70 of the user to bear on. Arranged above the respective air bags 30, 32 are a pair of opposite head holding air bags 40, 40 so as to be positioned at opposite sides of the portion (see FIG. 3) for the head 72 to bear on.

The therapeutic air bags 30, 32 and the head holding air bags 40, 40 are connected via electromagnetic valves to an unillustrated air pump, and are each controllable for inflation or contraction by the user's manipulation of the control unit 17 or according to a program.

The backrest 20, seat 12 and leg massage means 15 are each covered with a cushion, cover, etc., and the air bags 30, 32, 40, 13, 16 are invisible from outside. A cushion 22 resembling a pillow can be additionally provided on the portion for the head 72 of the user to bear on.

The therapeutic air bags 30, 32 can be generally in the shape of a parallelogram or rectangle extending longitudinally of the backrest 20 and are arranged symmetrically about the centerline of the backrest 20 (the portion for the spine of the user to bear on). As shown in FIGS. 1 to 3, it is desirable to arrange the therapeutic air bags 30, 32 generally in a V shape as spaced apart by a large distance at the upper side (head side) of the backrest 20, the distance decreasing from position to position downward. The large distance provided between the air bags at the shoulder side of the user makes it possible to greatly twist the upper half of the body of the user for massaging as will be described below.

The therapeutic air bags 30, 32 are controllable for inflation or contraction independently of each other.

The head holding air bags 40, 40 are arranged on the rear side of the pillowlike cushion 22 and hold the head 72 of the user therebetween against leftward or rightward movement or rotation when inflated as shown in FIG. 4(a) and FIG. 4(b).

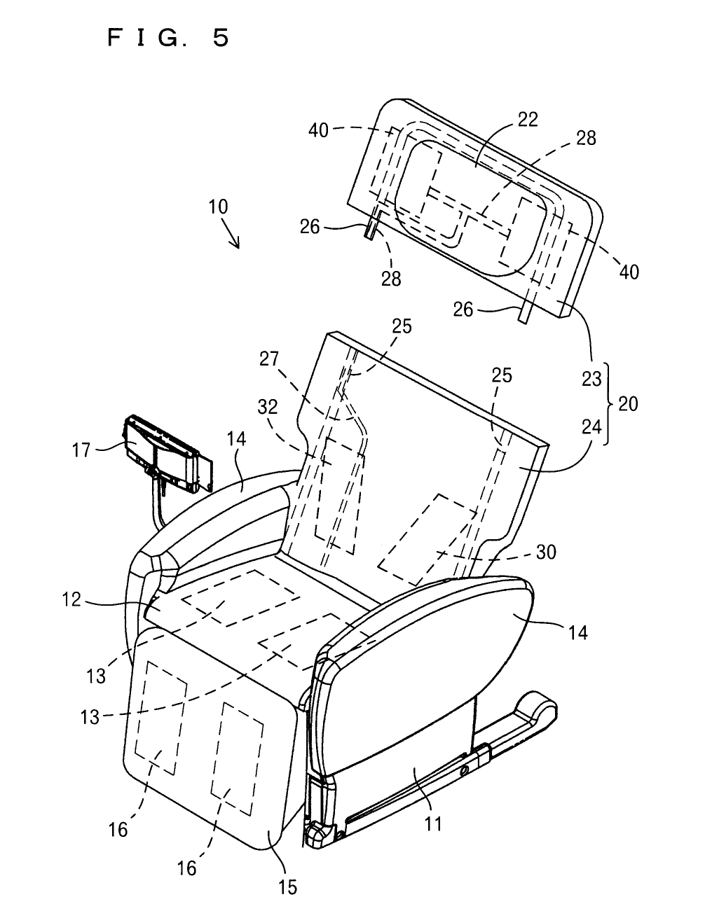

Since the backrest 20 has a large length, it is desirable that the backrest 20 be separable into segments when the chair-type massage machine 10 it to be shipped or transported. In this case, the backrest 20 can be made separable into a head segment 23 provided with the head holding air bags 40, 40, and a back segment 24 having the therapeutic air bags 30, 32 as shown in FIG. 5.

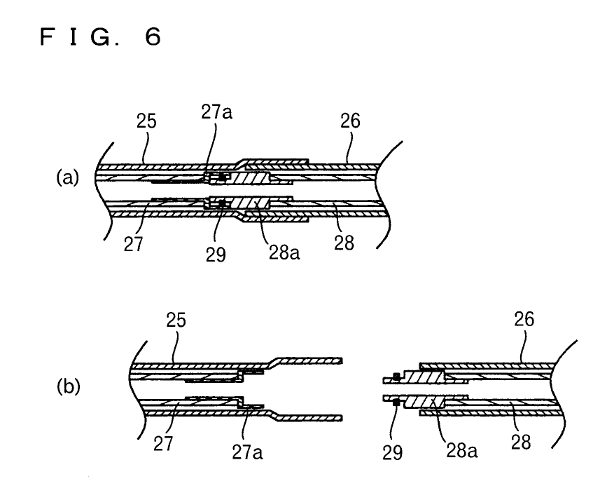

In order to make the backrest 20 easier to assemble and separate, the back segment 24 is provided with metal socket pipes 25, 25 at opposite sides of its upper end, and the head segment 23 is provided with spigot pipes 26, 26 fittable into the respective socket pipes 25, 25 as shown in FIG. 5. The socket pipes 25, 25 are diametrically enlarged at their upper ends for the spigot pipes 26, 26 to fit in easily (see FIG. 6).

The socket pipe 25 and the spigot pipe 26 at one side have respective hoses 27, 28 fitted therein for supplying compressed air from the air pump (not shown) to the head holding air bags 40, 40 therethrough as shown in FIG. 6. The hoses 27, 28 are provided at their opposed ends with respective resin joints 27a, 28a and a rubber packing 29 so that the hoses can be connected together without permitting air leakage when the spigot pipe 26 is engaged in the socket pipe 25. The hose 28 in the head segment 23 is branched at the other end thereof and connected to the head holding air bags 40, 40.

Since the backrest 20 is thus constructed, the massage machine can be transported with the backrest 20 separated. When the machine is to be used, the spigot pipes 26 of the head segment 23 as separated from the back segment 24 are inserted into the socket pipes 25 of the back segment 24 for engagement, with the hoses 27, 28 connected together by the joints 27a, 28a.

Consequently, the head segment 23 is fixed to the back segment 24, and the head holding air bags 40, 40 are made ready for the supply of compressed air.

When the user, sitting down on the seat 12 and leaning against the backrest 20, selects a twisting massage by manipulating the control unit 17 or under the control of a program, the head holding air bags 40, 40 inflate, holding the head 72 of the user therebetween as shown in FIG. 4(a) and FIG. 4(b). In this state, only one of the therapeutic air bags 30 and 32 is inflated as shown in the drawing 4(a) or 4(b), whereby the upper half of the body of the user is pushed forward by the inflated air bag 30 or 32. With the head 72 of the user held at rest by the head holding air bags 40, 40 against a leftward or rightward movement or rotation at this time, the body of the user is subjected to a twisting force about the spine by his or her upper right or left half body being pushed forward.

The shoulder of the user can be pushed forward effectively, causing a great twisting force to act on the upper half of the body of the user because the therapeutic air bags 30, 32 are in a V-shaped arrangement as seen in FIGS. 1 to 3.

Next, the inflated air bag 30 or 32 is contracted with the other air bag 30 or 32 only inflated, whereby the other side of the body opposite to the above is subjected to a forwardly pushing twisting force.

The upper half body of the user is given a twisting massage about the spine by repeating the above twisting action, whereby the body is massaged very effectively for correcting the spine, and softening or relaxing and stretching muscles.

In the case where the therapeutic air bags 30, 32 are arranged generally in a V shape, a twisting massage can be given by inflating and contracting the air bags 30, 32 only alternately with the head holding air bags 40, 40 dispensed with or without inflating these air bags 40, 40 although the effect produced is lesser than by the foregoing embodiment. Furthermore, a pressure massage can of course be given by inflating the therapeutic air bags 30, 32 at the same time.

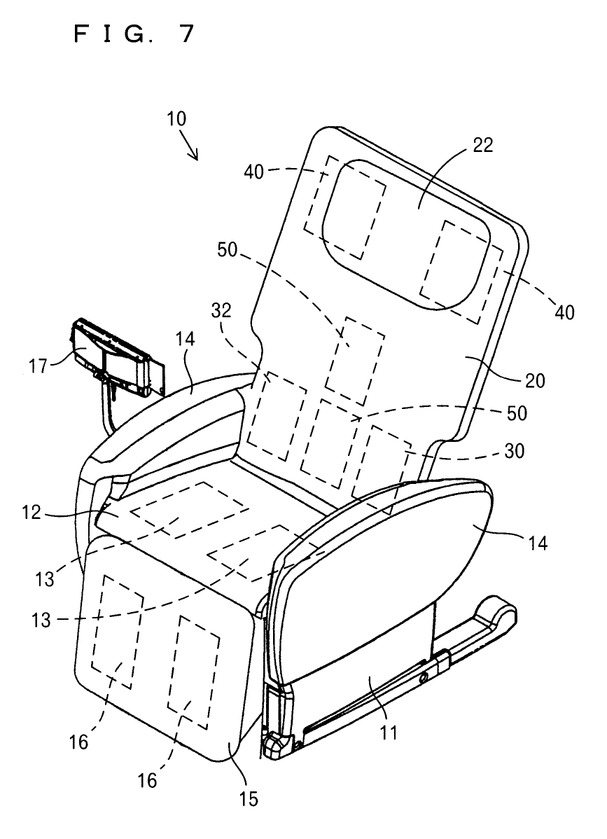

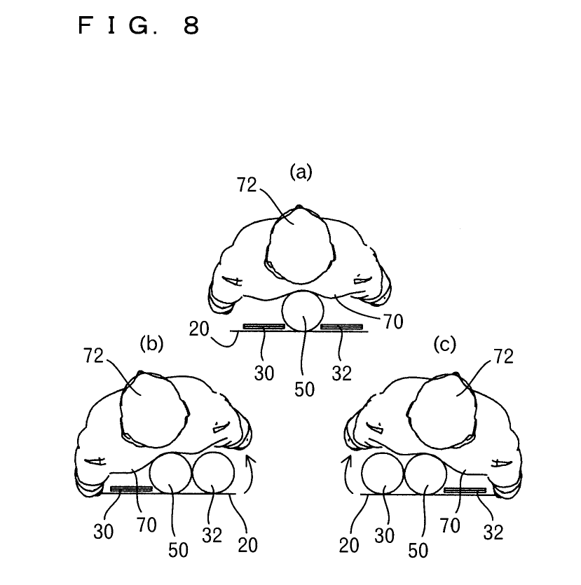

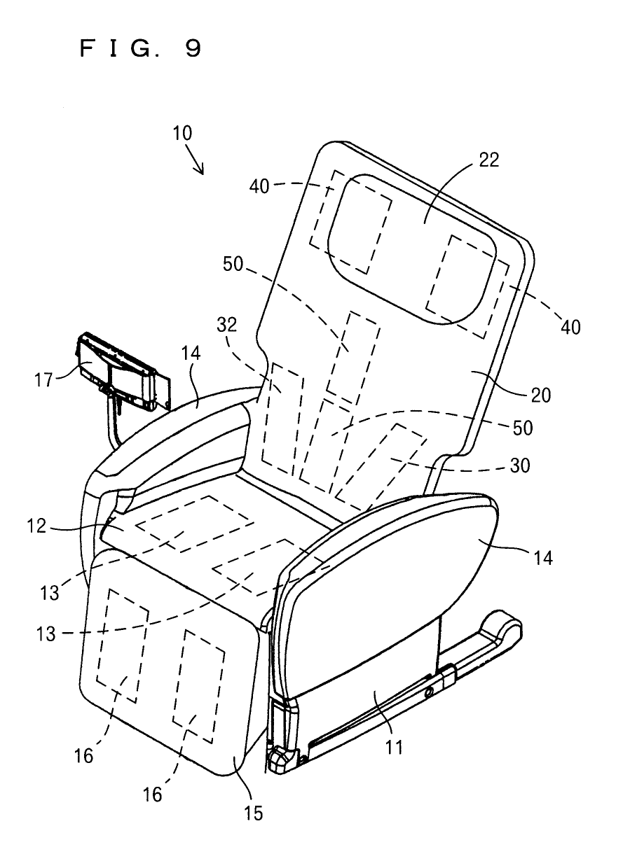

FIG. 7 shows central air bags 50, 50 arranged between opposite therapeutic air bags 30, 32. With the central air bags 50, 50 inflated as shown in FIG. 8(a), the therapeutic air bags 30, 32 are inflated and contracted alternately as seen in FIG. 8(b) and FIG. 8(c) to give a twisting massage. Although the head 72 is held by inflating the head holding air bags 40, 40 also in this case, these air bags 40, 40 are not shown in FIG. 8. With this illustrated embodiment in FIG. 7, two central air bags 50, 50 are arranged one above the other, and the therapeutic air bags 30, 32 are arranged respectively at opposite sides of the lower central air bag 50, whereby a twisting massage is given about the waist. However, the embodiment is not limitative with respect to the number of central air bags 50 and the arrangement of therapeutic air bags 30, 32. For example, the therapeutic air bags 30, 32 can be arranged generally in a V shape as shown in FIG. 9.

With the head holding air bags 40, 40 dispensed with or without inflating these air bags 40, 40, a twisting massage can be given by inflating and contracting the therapeutic air bags 30, 32 alternately while inflating the central air bags 50 although the effect produced is lesser than by the above embodiment. The massage to be given in this case serves to fully stimulate the spine instead of being a twisting massage.

Thus, the present invention provides a chair-type massage machine which is useful for giving a twisting massage to the upper half of the body of the user.

What is claimed is:

1. A chair-type massage machine comprising a seat for the user to sit in, and a backrest disposed at a rear end of the seat, the backrest being provided with a pair of opposite therapeutic air bags for massaging the back of the user, the chair-type massage machine being characterized in that:
the pair of opposite therapeutic air bags are arranged in a V shape and spaced apart by a large distance at an upper side of the backrest, the distance decreasing from portion to portion downward.

2. The chair-type massage machine according to claim 1 wherein a central air bag is disposed between the pair of opposite therapeutic bags.

3. The chair-type massage machine according to claim 2 wherein the opposite therapeutic air bags are alternately inflated with the central air bag inflated.

4. The chair-type massage machine according to claim 1 wherein head holding air bags for holding the head of the user therebetween are provided in the backrest respectively at opposite sides of a portion thereof for the head to bear on, and a twisting massage is given to the upper half of the body of the user by alternately inflating the therapeutic air bags in the backrest with the head of the user held between the head holding air bags by inflating the holding air bags.

5. A chair-type massage machine comprising a seat for the user to sit in, and a backrest disposed at a rear end of the seat, the backrest being provided with a pair of opposite therapeutic air bags for massaging the back of the user and a central air bag disposed between the therapeutic air bags, the chair-type massage machine being characterized in that: the pair of opposite therapeutic air bags are alternately inflated with the central air bag inflated.
